(19) United States
(12) Patent Application Publication
(10) Pub. No.: US 2024/0381889 A1
(43) Pub. Date: Nov. 21, 2024

(54) Whipped Cream Dispenser

(71) Applicant: Micro Matic USA, INC., Brooksville, FL (US)

(72) Inventor: Joseph M. Lisiecki, Spring Hill, FL (US)

(73) Assignee: Micro Matic USA, INC., Brooksville, FL (US)

(21) Appl. No.: 18/669,112

(22) Filed: May 20, 2024

Related U.S. Application Data
(60) Provisional application No. 63/467,687, filed on May 19, 2023.

(51) Int. Cl. A23C 13/14; B01F 23/20; B01F 23/2326; B01F 23/235; B01F 23/237; B01F 25/31; B01F 25/312; B01F 35/221; B01F 35/71; B01F 101/07

(52) U.S. Cl. CPC A23C 13/14; B01F 23/2326; B01F 23/235; B01F 23/237611; B01F 23/23762; B01F 23/23765; B01F 23/291; B01F 25/31114; B01F 25/312; B01F 35/2213; B01F 35/7176; A23C 2210/30; B01F 2101/07; B01F 2215/0468

(57) ABSTRACT

A whipped cream dispenser including a main body comprising a frame, a base, and a top portion, the top portion including a user interface with a touchscreen. The main body includes a pump for introducing a refrigerated ingredient, at least one surface passage tube containing the refrigerated ingredient, a mixing manifold for receiving an injection of one or more flavors, a NIM venturi for receiving the one or more flavors and for receiving an injection of gas to produce a gas-infused mixture, and a whipper tube comprising a whipper wand, the whipper wand configured to force the gas-infused mixture into the refrigerated product to produce a final whipped product.

### CROSS-REFERENCE TO RELATED APPLICATION

The present application claims priority to U.S. Patent Application No. 63/467,687, entitled: Whipped Cream Dispenser, filed on May 19, 2023, the contents of which are hereby incorporated by reference in their entirety.

### FIELD

The present disclosure relates to whipped cream dispensers and, specifically, to a whipped cream dispenser capable of dispensing natural cream without additives from virtually any gas, on demand, using an electronic control system and touchscreen to make it user-friendly and efficient.

### BACKGROUND

Typical shipped cream dispensers are batch whip machines that require a user to wait an extended period of time for the liquid to cool before dispensing. Whipped cream machines currently on the market require disassembly on a regular basis, in most cases daily. This often requires several internal parts including gears, flow path parts, and o-ring seals to be soaked in sanitizing solution for an extended period of time at which point they require re-lubrication and re-assembly. This a time-consuming and often confusing process that requires a great deal of attention and diligence on the part of the operator.

In addition, some smaller canister-type whip dispensers use vials of gases such as Nitrous oxide (N₂O) under very high pressure as “chargers” in order to pressurize the canister. These types of machines provide a whip product that does not maintain volume for more than a few minutes. Many of these machines contain ingredients that are known to cause health issues. Of even more concern, after vigorous shaking of the canister, the release of the pressurized gas results in a mood-altering and potentially harmful substance known as “laughing gas” or “whippets” as well as presenting other high-pressure safety concerns.

Other drawbacks with present whip dispensers are that they require extensive hand-mixing or shaking to obtain different flavor variations and require methods of disposal of the empty canisters that are not eco-friendly.

What is therefore needed is a whipped cream dispenser that addresses the above-identified drawbacks associated with current whipped cream dispensers.

### SUMMARY

The whipped cream dispenser of the present disclosure is capable of dispensing whipped cream or variations of whipped toppings including floating topper, liquid, dairy, and standing whip. The whipped cream dispenser of the present disclosure dispenses plain natural cream without any required additives to enhance shelf life, slump/volume degradation, questionable propellants, or container disposal concerns.

Unlike current whip machines, the whipped cream dispenser presented in this disclosure produces whipped products that can be made with virtually any gas such as Nitrogen (N₂) and carbon dioxide (CO₂) or even breathing air, at a comparatively low pressure, instead of controlled substances like nitrous oxide (N₂O). The dispenser of the present disclosure advantageously allows whipped products containing various or multiple flavorings/gasses to be released on-demand using an electronic/computer controlled LCD touchscreen and user interface that that allows dispensing of various pre-set or continuous serving volumes.

The whipped cream dispenser of the present disclosure utilizes bulk dairy/non-dairy products for a continuous use providing nonstop dispense and also includes an electronically controlled semi-automatic sanitizing system where it is not required to remove product vessels and there is little or no disassembly of the machine components for the process of sanitizing.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates a perspective view of the whipped cream dispenser of the present disclosure;

FIG. 2 illustrates a side view of the whipped cream dispenser of the present disclosure;

FIG. 3 illustrates a front view of the whipped cream dispenser of the present disclosure;

FIG. 4 illustrates a top view of the whipped cream dispenser of the present disclosure; and

FIG. 5 illustrates various views of the whipped cream dispenser of the present disclosure.

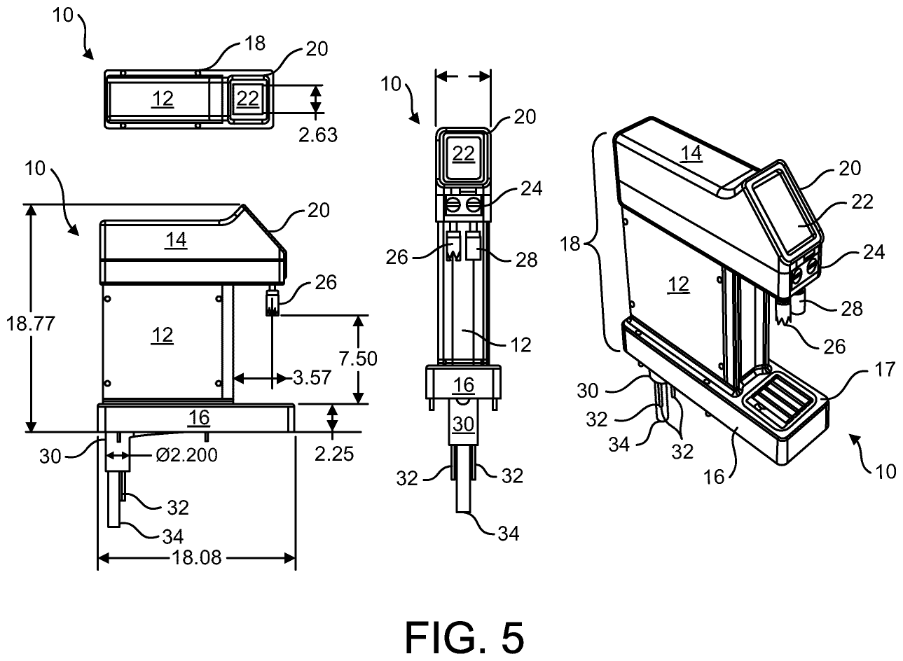

### DETAILED DESCRIPTION

Reference will now be made in detail to the following exemplary embodiments, which are illustrated in the accompanying drawings, wherein like reference numerals refer to like elements throughout. The exemplary embodiments may be embodied in various forms without being limited to the exemplary embodiments set forth herein. Descriptions of well-known parts are omitted for clarity.

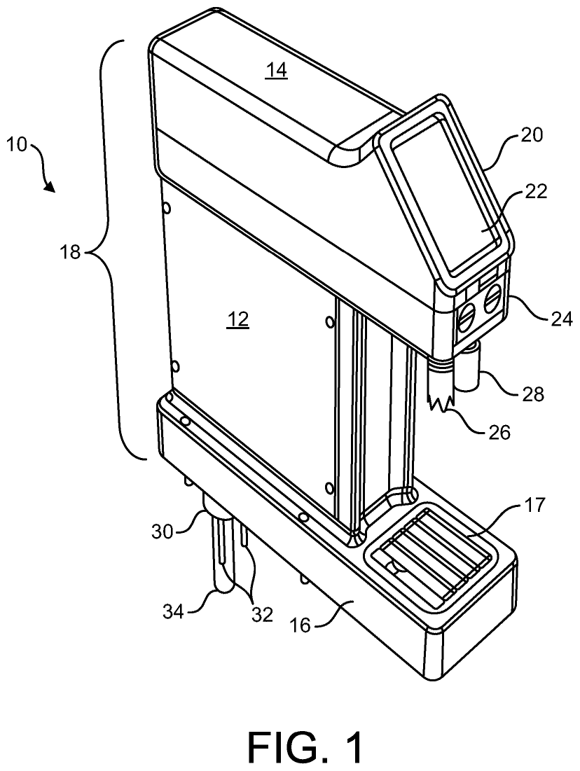

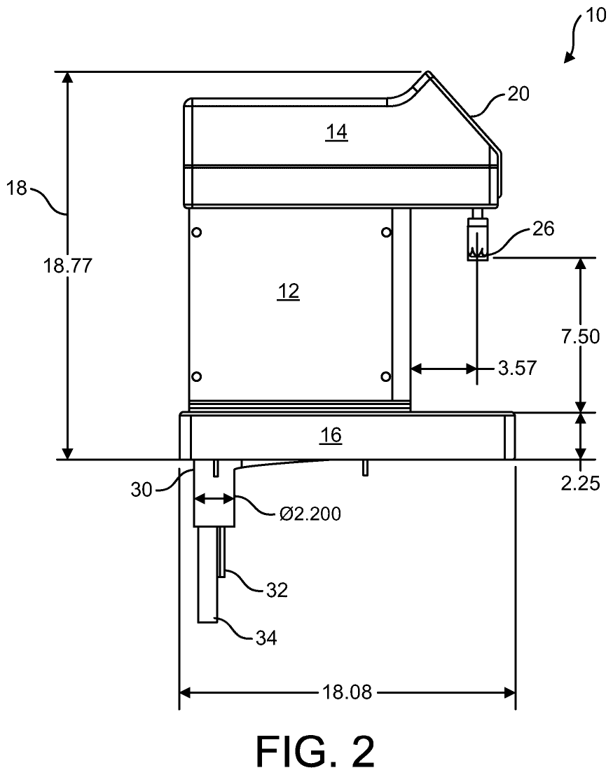

Referring now to FIGS. 1 and 2, a whipped cream dispenser 10 of the present disclosure can be seen. Dispenser 10 includes a frame 12, a top section 14, and base 16 having, in one embodiment, a removable grill 17. Frame 12, top section 14 and base 16 collectively form a body 18 of dispenser 10. An LCD display 20 is attached at one end of top section 14 and includes a touchscreen and user interface 22. Below the user interface 22 are whipper removal ports 24, and a pair of nozzles, whip nozzle 26 and topper nozzle 28. Whipper removal ports 24, are an optional feature and are comprised of a labyrinth of small passages. In the event that the settings are outside normal running, butter can be produced from heavy cream. If this should occur, ports 24 can be used to remove the cap, spring, and whipper for cleaning. In one embodiment, one or both of whip nozzle 26 and topper nozzle 28 are detachable and removable from dispenser 10. Topper nozzle 28 dispenses a high slump whip that lays on the surface of a beverage in a high viscosity, flat, melted marshmallow-like, topping.

Extending from the bottom of base 16 are a surface passage tube 30, supply lines 32, and a drain tube 34. Surface passage tube 30 is a structural tube that is part of the framework of dispenser 10. Tube 30 has a minimum of ¼″ insulation on its inner walls. Tube 30 is used as a conduit for the refrigerated ingredient in the refrigerated cabinet below. Supply lines 32 are a chilled water circulation loop. Lines 32 can be copper or aluminum. This keeps the dispense components below the required NSF temperature for holding dairy products at less than 40 degrees Fahrenheit. Drain tube 34 is a tube that comes from the drip tray. Other tubes not shown in the drawings may also be used that will carry cream products, flavorings, and gas.

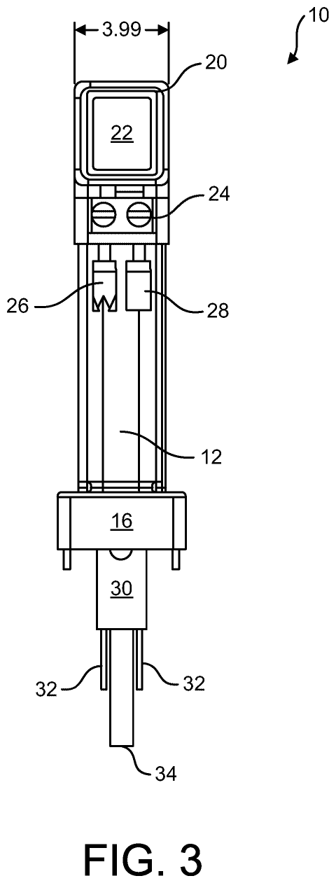

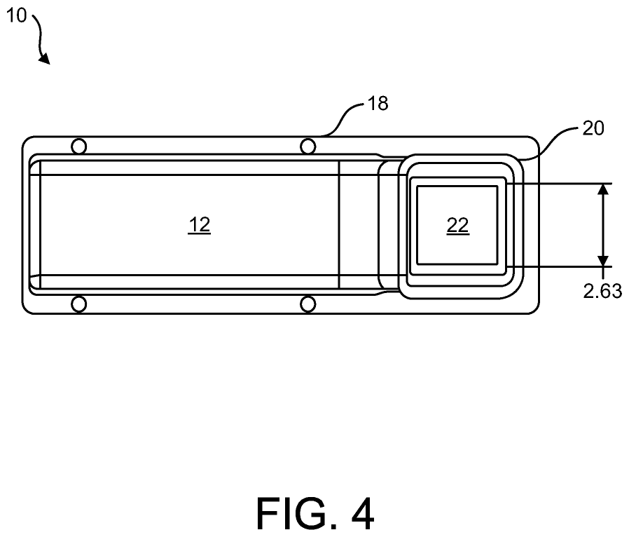

FIGS. 3 and 4 are, respectively, front and top views of whipped cream dispenser 10 and illustrate the same components as shown in FIGS. 1 and 2.

In one embodiment, the dispenser includes a processor and associated software and electronics to provide complex timing and switching regarding the selection and dispensing of the final product, providing accurate control of the dispensing of ingredients, thus taking many tedious tasks away from the operator, resulting in many more useful options to the user.

The dispenser described herein includes a flavor blending apparatus and a churning apparatus. In one embodiment, the dispenser utilizes miniature Nitrogen Infusion Module (MiniNIM™) technology to infuse any type of gas into liquid at a comparatively low pressure, for example, less than 100 psig, prior to flowing through the flavor blending apparatus and then through the churning apparatus to make variations in thickness of the final whipped product. Thickness preference may be regulated by the gas pressure that is metered by an electronic regulator controlled on a slider bar adjustment of touchscreen 22.

Advantageously, the continuous flow path of the dispenser never exceeds a diametrical volume at any point where a flowing sanitizer cannot reach every surface where bacteria would hide in excess of that which would fail NSF testing with little or no disassembly. In one non-limiting use-based embodiment of the flow path, the cream is pumped in, flavors are injected into a mixing manifold, and this mix flows through the NIM venturi where gas is injected. This gas-infused mix flows through the whipper tube in which a whipper wand with a tortuous path further forces the gas and flavors into the product to form the final whip product. The more gas is infused, the thicker the final whip product. The topper uses a lower pressure.

Bulk product packages are kept cold in a refrigerated compartments. These can be switched during the dispense cycle or alternatively, larger volumes can be kept in a walk-in cooler onsite and pumped to the dispenser, much like a beer system.

The whipped cream dispenser of the present disclosure utilizes bulk dairy and non-dairy products to provide a continuous-use and non-stop dispense of the final whipped product. Unlike prior whipped cream dispensers, the disclosed whip dispenser includes an electronically controlled semi-automatic sanitizing system. Thus, it is not required to remove product vessels and little or no disassembly of the machine components is required for the process of sanitizing the machine after use.

Unlike prior art machines that use a controlled substance like Nitrox Oxide (NO₂), which has known dangerous side effects, the final whipped products that are produced by the whipped cream dispenser of the present disclosure can utilize virtually any type of gas such as, for example, Nitrogen (N₂), carbon dioxide (CO₂), or ambient, breathing air, at a comparatively low pressure. For example, the cream is usually between approximately 70-80 psi. Lower pressures can be achieved, but this may cause lower volume dispensed at whip nozzle 28. The gas is at approximately the same pressure or in some instances a pound or two higher. Flavors are slightly above the cream pressure in order to push into the stream whereas, the gas has the lower pressure zone in the venturi that allows it to flow in at a lower pressure. The whipped cream dispenser of the present disclosure can produce whipped products containing various or multiple flavorings/gasses on demand using an electronic control system to meter selections from touchscreen 22 and dispensing various pre-set or continuous serving volumes.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

1. A whipped cream dispenser comprising:
a main body comprising a frame, a base, and a top portion, the top portion including a user interface with a touchscreen;
the main body including:
a pump for introducing a refrigerated ingredient;
at least one surface passage tube containing the refrigerated ingredient;
a mixing manifold for receiving an injection of one or more flavors;
a NIM venturi for receiving the one or more flavors and for receiving an injection of gas to produce a gas-infused mixture; and
a whipper tube comprising a whipper wand, the whipper wand configured to force the gas-infused mixture into the refrigerated product to produce a final whipped product.

2. A method of whipping and dispensing a product, the method comprising:
pumping cream into a mixing manifold;
injecting at least one flavor into the mixing manifold to mix with the cream to produce flavored cream;
directing the flavored cream through a NIM Venturi apparatus;
infusing a gas at a predetermined pressure into the NIM Venturi apparatus to produce a gas-infused mixture; and
directing the gas-infused mixture into a churning apparatus to produce a final whipped product.

3. The method of claim 2, further comprising adjusting gas pressure via an electronic regulator to regulate thickness of the final whipped product.

4. The method of claim 2, where the final whipped product is dispensed in a continuous-use, uninterrupted fashion.

5. The method of claim 2, wherein the infused gas is nitrogen gas (N₂).

6. The method of claim 2, wherein the infused gas is carbon dioxide (CO₂).

7. The method of claim 2, wherein the infused gas is ambient air.

8. The method of claim 2, wherein the predetermined pressure is between approximately 70 and 80 psi.
